(19) United States
(12) Patent Application Publication
(10) Pub. No.: US 2009/0258154 A1
(43) Pub. Date: Oct. 15, 2009

(54) COATINGS AND METHODS FOR IMPROVED ADHESION TO PLASTIC

(75) Inventors: Timothy S. December, Rochester Hills, MI (US); Binh Nguyen, Southfield, MI (US); William H. Merritt, Ferndale, MI (US)

Correspondence Address: Harness, Dickey and Pierce, P.L.C., 5445 Corporate Drive, Troy, MI, 48098, US

(73) Assignee: BASF CORPORATION, Southfield, MI (US)

(21) Appl. No.: 12/103,045

(22) Filed: Apr. 15, 2008

(51) Int. Cl. C08F 2/50

(52) U.S. Cl. 427/517

(57) ABSTRACT

Compositions and methods are provided that increase adhesion of a primer, such as an adhesion promoter, to a plastic substrate and/or increase adhesion of a topcoat to the primer. Chemical properties at the interface of the substrate and the adhesion promoter coating and/or chemical properties at the interface of the adhesion promoter coating and topcoat are modified in order to improve adhesion.

### INTRODUCTION

Thermoplastic polyolefins (TPO) are widely used in the automotive industry to form automobile bumpers, fascia, and the like because these materials are durable, cost effective, easily molded into complex shapes, and can be recycled. However, a major challenge in using TPO is the poor adhesion of coatings and paints, such as topcoats, to the TPO. This can be due to lack of functionality on the TPO that leads to poor wettability, inertness, and low surface energy, as described in Ryntz, R. A.; Holubka, J. W.; Kaberline, S. L.; Prater, T. J.; J. Coat. Tech. 1996, 68, 83.

Several methods are used to improve adhesion to TPO. In general, these methods can be classified as either oxidation or primer methods. In the oxidation method, the TPO surface is oxidized by treatment with flame, corona discharge, plasma, UV radiation, or chemical oxidizing agents. These methods include those described in Wu, S.; Polymer Interface and Adhesion; New York, Marcel Dekker 1982, 296; Garbassi, F.; Morra, M.; Occhiello, E. Polymer Surfaces: From Physics to Technology, New York: Wiley 1994, Chapter 10; Yasuda, H. K.; Lin, Y-S. J. Polymer Sci. B 2002, 40, 623; Meister, J. Polymer Modification: Principles, Techniques, and Applications, New York: Marcel Dekker 2000, 251; Kiss, E.; Samu, J.; Toth, A.; Bertoti, I. Langmuir 1996, 12, 1651; and Zand, A.; Aronson; C. L.; Beholz, L. G. Polymer 2005, 46, 4604. As a result of the oxidation method, a more polar surface is produced due to formation of an oxide layer or introduction of polar functionality which promotes adhesion of the coating layer to the TPO. However, there are several disadvantages to the oxidation method. First, the substrate must be coated soon after treatment because of the reversibly short lifetime of the radical species. Second, chain scission on the surface of the TPO can occur due to over-treating. And third, non-uniform oxidation coverage can lead to cohesive failure on the TPO's surface, for example, as described by Sass, C.; Clemens, R. J.; Lawniczak, J. E. Prog. Org. Coat. 1994, 24, 43.

In the primer method, an adhesion promoter coating is applied to the TPO surface to provide a coating layer with increased polarity, which in turn promotes adhesion of a second coating layer, such as a topcoat, to TPO. Common adhesion promoter coatings used in the automotive industry are based on chlorinated polyolefin (CPO). Although using CPO requires an additional coating layer (i.e., the adhesion promoter) to increase adhesion between the TPO and the second coating layer or topcoat, the primer method is one of the leading methods because it offers flexibility for use with diverse applications and types of TPO substrates and subsequent coating layers. U.S. Pat. No. 6,939,916 to Merritt et al. discloses adhesion promoters and coating compositions for adhesion to olefinic substrates.

### SUMMARY

The present invention provides compositions and methods that increase adhesion of coatings to plastic, especially TPO substrates. Chemical properties at the interface of the substrate and the adhesion promoter coating and/or chemical properties at the interface of the adhesion promoter coating and a second coating layer, such as a topcoat, may be modified to improve adhesion. The present compositions and methods may also be used in conjunction with oxidation methods to improve adhesion.

Adhesion at the interface of the substrate and the adhesion promoter coating layer can be increased in accordance with the present compositions and methods. At least a portion of an adhesion promoter coating may be overcoated with a second coating layer, such as a topcoat, where the adhesion promoter coating includes a compound having a saturated carbon-carbon bond and the second coating layer includes a base. The compound having a saturated carbon-carbon bond is dehydrogenated with the base to form an unsaturated carbon-carbon bond.

In some embodiments, a method of coating includes overcoating at least a portion of an adhesion promoter coating with a second coating layer, where the adhesion promoter coating includes a compound having a saturated carbon-carbon bond and the second coating layer includes a base. The compound having the saturated carbon-carbon bond in the adhesion promoter coating is dehydrogenated with the base to form an unsaturated carbon-carbon bond. The compound in the adhesion promoter coating may include a halogen bonded to one carbon of the saturated carbon-carbon bond and the dehydrogenating step may therefore include dehydrohalogenation to form the unsaturated carbon-carbon bond. The base in the second coating layer may be an amine compound.

In some embodiments, the second coating layer may further include a compound having a hydroxyl group and the compound having a saturated carbon-carbon bond in the adhesion promoter coating may further include an anhydride group. The anhydride group may be hydrolyzed to form a carboxylic acid group and an ester bond between the hydroxyl group of the compound in the second coating layer and the carboxylic acid group of the compound in the adhesion promoter.

In some embodiments, a method of coating a polymeric substrate includes the step of applying an adhesion promoter coating to a least a portion of a polymeric substrate, wherein the adhesion promoter coating includes a compound having a saturated carbon-carbon bond. The applied adhesion promoter may be fully or partially cured or dried at this point. This is followed by an overcoating step, where at least a portion of the adhesion promoter coating is overcoated with a second coating layer, the second coating layer including a base. The second coating layer may be fully or partially cured or dried at this point, along with the adhesion promoter if the adhesion promoter is not already cured. The base in the second coating layer may be an amine compound and the compound having a saturated carbon-carbon bond in the adhesion promoter coating may be a chlorinated polyolefin. The polymeric substrate may be a thermoplastic polyolefin substrate.

In some embodiments, a second coating composition or a topcoat composition includes an organic solvent, a film-forming resin, and a tertiary amine, wherein the second coating layer composition is substantially free of water. Coated polymer substrates may be prepared by applying an adhesion promoter coating and overcoating at least a portion of the adhesion promoter coating layer using the second coating composition and the present methods.

Adhesion at the interface of the adhesion promoter coating layer and a second coating layer can be increased in accordance with the present compositions and methods. A portion of a polymeric substrate is coated with a layer of an adhesion promoter coating, the adhesion promoter coating including a free radical initiator. A covalent bond is formed between the adhesion promoter coating and the polymeric substrate using a free radical generated from the free radical initiator.

In some embodiments, a method of coating a polymeric substrate includes coating at least a portion of a polymeric substrate with a layer of an adhesion promoter coating, where the adhesion promoter coating includes a free radical initiator. This is followed forming a covalent bond between the adhesion promoter coating and the polymeric substrate using a free radical generated from the free radical initiator. Initiating the formation of a covalent bond may include irradiating the adhesion promoter coating with ultraviolet light or an electron beam and/or heating the polymeric substrate and layer of adhesion promoter coating.

In some embodiments, a method of coating a polymeric substrate includes applying an adhesion promoter coating to a least a portion of a polymeric substrate, wherein the adhesion promoter coating includes a free radical initiator. The applying step is followed by overcoating at least a portion of the adhesion promoter coating with a second coating layer. A coated polymeric substrate may be prepared according to the present methods and using the present coating compositions.

Adhesion at both the interface of the substrate and the adhesion promoter coating layer and the interface of the adhesion promoter coating layer and a second coating layer can be increased in accordance with the present compositions and methods. At least a portion of a polymeric substrate is coated with a layer of an adhesion promoter coating, the adhesion promoter coating comprising a free radical initiator and compound having a saturated carbon-carbon bond, such as a chlorinated polyolefin. A covalent bond is formed between the adhesion promoter coating and the polymer substrate using a free radical generated from the free radical initiator. At least a portion of the adhesion promoter coating layer is overcoated with a second coating layer, such as a topcoat, including a base. The saturated carbon-carbon bond of the compound in the adhesion promoter coating is dehydrogenated with the base to form an unsaturated carbon-carbon bond. The unsaturated carbon-carbon bond of the compound in the adhesion promoter coating may participate in pi bonding (π-π) interactions with the substrate.

The present compositions and methods afford several benefits by increasing adhesion between different coating layers and by increasing adhesion between one or more coating layers and the substrate to which they are applied. Without being bound by theory, the present compositions and methods may produce a net increase of chemical interactions between the layers that subsequently increases adhesion. In particular, formation of covalent bonds between coating layers, such as the second coating layer and adhesion promoter, and/or formation of covalent bonds between the adhesion promoter and the substrate may occur. Increases in hydrogen bonding may occur. Likewise, pi bonding (π-π) interactions between unsaturated carbon bonds in the adhesion promoter coating layer and the substrate may occur. These chemical interactions may afford considerable improvements in adhesion between the second coating layer and adhesion promoter coating layer and between the adhesion promoter coating layer and the polymeric substrate. Durability and performance of coated polymeric substrates may be improved using the present compositions and methods.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. In addition, disclosure of ranges includes disclosure of all distinct values and further divided ranges within the entire range.

### DRAWINGS

Certain aspects of the present invention will be more fully understood from the detailed description and the accompanying drawings, in which:

FIG. 1 illustrates the initial condition at interfaces;

FIG. 2 illustrates interactions after heating;

FIG. 3 illustrates a typical TPO composition;

FIG. 4 illustrates effects by variables;

FIG. 5 illustrates percent adhesion for different substrates at 30 minutes in the gas soak test;

FIG. 6 illustrates percent adhesion for different substrates at 60 minutes in the gas soak test; and

FIG. 7 illustrates percent adhesion for different substrates at 90 minutes in the gas soak test.

The drawings described herein are for illustration purposes only and are not intended to limit the scope of the present disclosure in any way.

### DETAILED DESCRIPTION

Further areas of applicability and advantages will become apparent from the following description. It should be understood that the description and specific examples, while exemplifying various embodiments of the invention, are intended for purposes of illustration and are not intended to limit the scope of the invention.

The present invention provides coatings and methods for improved adhesion of coating layers to plastic. Adhesion at the interface of the substrate and the adhesion promoter coating layer and/or adhesion at the interface of the adhesion promoter coating layer and a second coating layer can be increased in accordance with the present compositions and methods. In particular, the present invention includes chemical mechanisms to improve durability of one or more coating layers on plastic substrates. As used in the present disclosure, substrates include TPO substrates, an adhesion promoter coating composition may comprise CPO, and a second coating layer may be a topcoat.

Adhesion between an adhesion promoter coating layer and substrate depends on many factors, including, for example, the type and nature of the adhesion test performed, baking temperature, modulus of the substrate, amount of impact modifier in the substrate, thickness at the interface, and residual solvent or plasticizer in the TPO substrate. Impact modifiers are described in U.S. Pat. No. 5,021,500 to Puydak et al. Factors influencing the adhesion of adhesion promoter coatings to TPO substrates may be adjusted to improve adhesion.

Chemical features of the adhesion promoter coating can also influence the interaction with the substrate and how that interaction is affected by external factors. For example, adhesion promoters having non-chlorinated polyolefins (NCPO) may perform better than adhesion promoters having CPOs in a gasoline soak test because NCPOs have less functionality and are therefore less soluble in an organic solvent such as gasoline, as described by Williams, K. A.; Germinario; L. T.; Eagan, R. International Coating for Plastics Symposium 2003, Troy, Mich., USA. However, the opposite is true for a peel strength test, as described by Lawniczak, J. E.; Williams, K. A.; Germinario, L. T. J. Coat. Tech. Res. 2005, 2, 399. Temperature also plays an important role in adhesion, where higher bake temperature may significantly improve coating adhesion in the gasoline soak test. Higher temperatures can also improve adhesion in a flexural modulus test because there may be more entanglement between the materials at the CPO-TPO interface, as described by December, T. S.; Merritt, W.; Menovcik, G. International Coating for Plastics Symposium 2005, Troy, Mich., USA. Another factor is the amount of impact modifier in the TPO. Ryntz and coworkers used lap-shear tests to measure the strength of CPO-TPO interface adhesion and demonstrate that increasing the impact modifier by 0.3% can increase the strength of adhesion almost two-fold, as disclosed by Yin, Z.; Ma, Y.; Chen, W.; Coombs, N.; Winnik, M. A.; Yaneff, P. V.; Ryntz, R. A. Polymer 2005, 46, 11610. In addition, the thickness of the CPO-TPO interface is also important. Theoretical and experimental studies show that in order to have good adhesion between topcoats and TPO, the range of thickness for the CPO-TPO interface should be from 11 nm to 400 nm, as disclosed by Dioh, N.; Zimba, C. G.; Mirabella, F. M. Poly. Eng. Sci. 2000, 40, 2000. The residual solvent in TPO before and after baking also influences the CPO-TPO adhesion. Increasing solvent before baking may allow or facilitate diffusion of the CPO into TPO surface. If less solvent is present after baking, the CPO-TPO adhesion increases. If the CPO-coated TPO is exposed to solvent after baking, the TPO matrix is swelled, which results in disruption of CPO-TPO adhesion.

The proposed physical and chemical mechanisms of CPO-TPO adhesion are complex. CPO-TPO adhesion may be the result of diffusion of CPO into the surface of TPO such that the CPO and TPO become entangled after baking. However, the chemistry at both the second coating layer-CPO interface and the CPO-TPO interface is also a critical factor for adhesion. The present compositions and methods include features that change the chemistry at the aforementioned interfaces in a way that improves adhesion. The present disclosure also provides chemical mechanisms for improving adhesion.

The present invention makes use of several different chemical effects in order to improve adhesion between coating layers and between coating layers and plastic substrates. Much attention in TPO adhesion is focused on physical aspects at the interface of the substrate and coating layer or the interface of consecutive coating layers. However, to fully understand the mechanism of adhesion, one must examine the chemical aspects of the system, especially the chemistry at the interface of layers. The present compositions and methods include and take advantage of particular chemical mechanisms to improve adhesion at the layer interfaces.

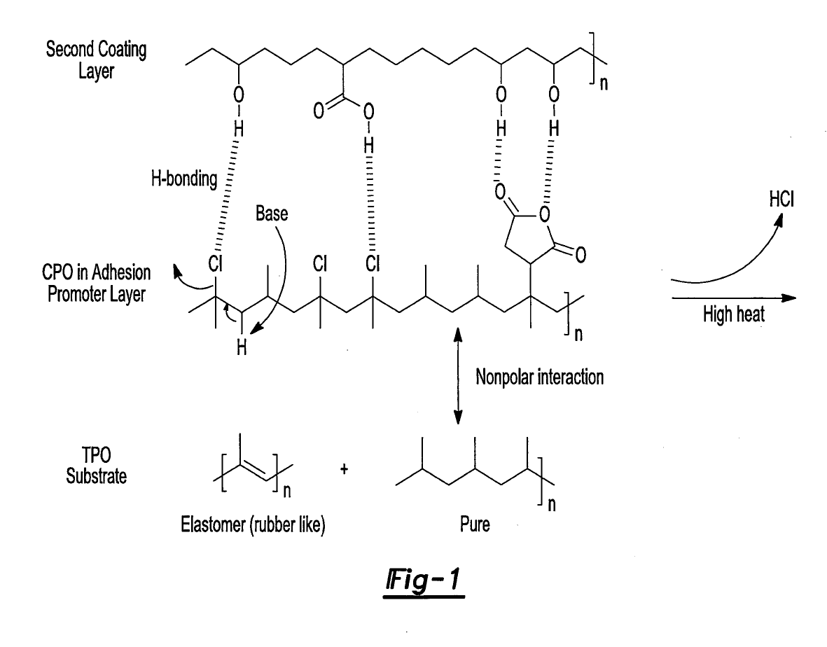

A chemical mechanism according to the present invention is illustrated in FIG. 1, where initially there is hydrogen bonding (H-bonding) between the polar groups in both the second coating layer (e.g., hydroxyl and carboxylic acid groups) and the CPO within an adhesion promoter layer (e.g., halogen, such as chlorine, and anhydride groups). With reference now to FIG. 1, non-polar interactions exist between aliphatic parts of the two layers at the CPO-TPO interface. When the system is heated to high temperature, some chlorides in the CPO of the adhesion promoter coating layer are unstable and a base in the second coating layer can diffuse into the CPO and catalyze the elimination of HCl from CPO (dehydrohalogenation), forming unsaturated carbon-carbon bonds (e.g., ethylenically unsaturated groups) in the adhesion promoter coating layer.

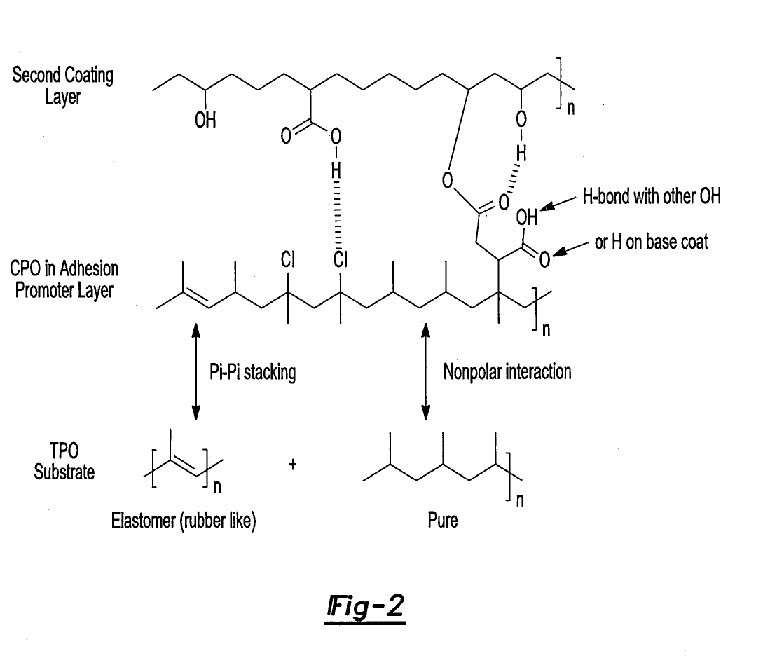

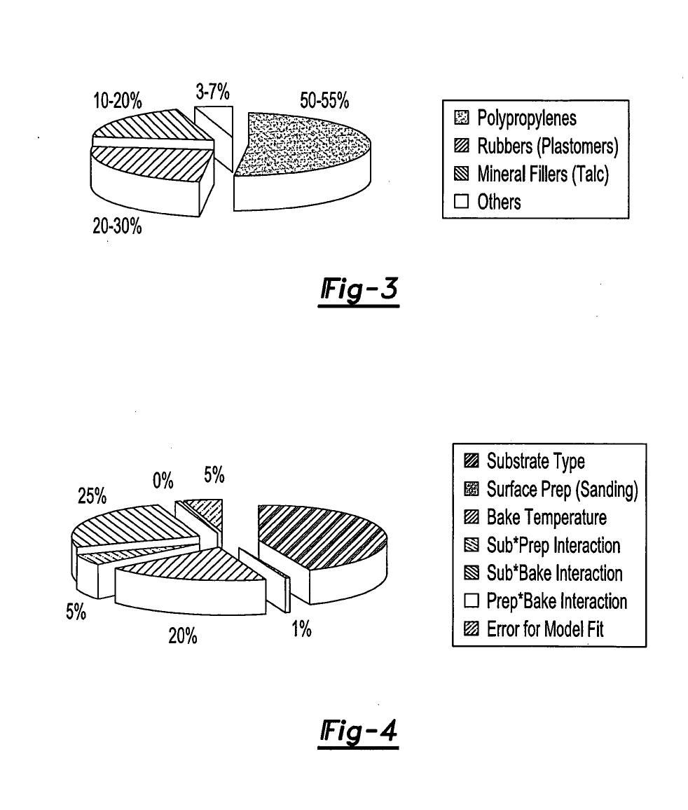

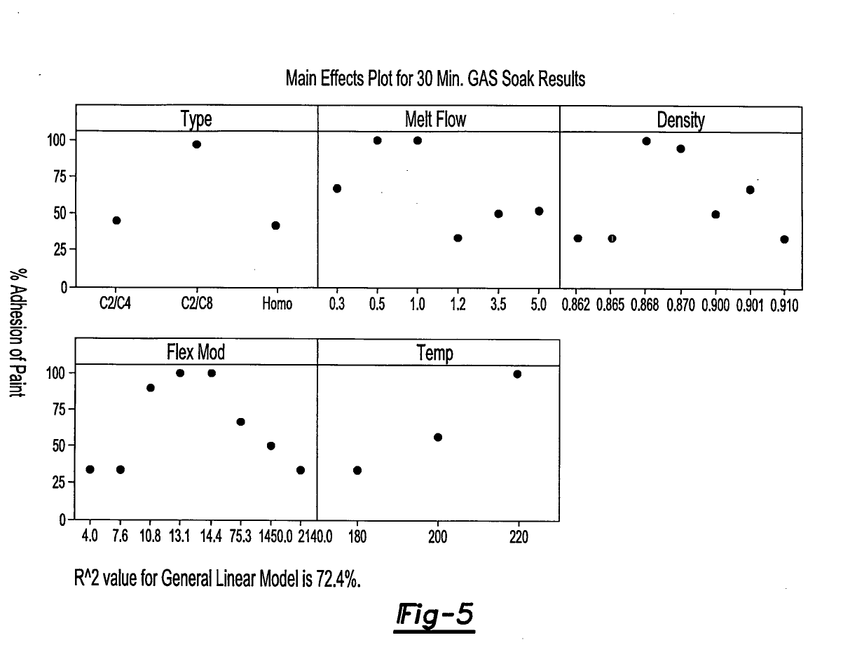

With reference to FIG. 2, the second coating layer may include a compound having a hydroxyl group and the compound having a saturated carbon-carbon bond in the adhesion promoter coating, such as CPO, may include an anhydride group. The anhydride group may be hydrolyzed to form a carboxylic acid group to form and an ester bond between the hydroxyl group of the compound in the second coating layer and the carboxylic acid group of the compound in the adhesion promoter. For example, compound with a hydroxyl group in the second coating layer may attack an anhydride in CPO to form an ester bond between the layers and a free carboxylic acid in the CPO. Overall, the system may lose one H-bond between the topcoat-adhesion promoter interface, but gains a covalent ester linkage and at least two more H-bonds from the newly formed carboxylic acid in the CPO; compare FIGS. 1 & 2. Consequently, there is a net increase of interactions between the layers that can increase adhesion.

In addition, the resulting unsaturated carbon-carbon bond (i.e., ethylene bond) in the CPO is thought to enhance the interaction between CPO and TPO through pi bonding (π-π) interactions if the TPO composition contains some rubber-like elastomers that, for example, have unsaturated carbon-carbon bonds or other more polar groups. Examples of rubber-like elastomers include those described U.S. Pat. No. 5,021,500 to Puydak et al. The overall result is better adhesion for the entire system.

Aspects of the present invention are further illustrated by the following examples, where adhesion promoter coating layers are applied to different plastic substrates. Eleven TPO test panels were used as substrates, each having a different composition as shown in Table 1. The TPOs are grouped by formula composition: homo-polypropylene, plastomers (C2/C4 and C2/C8 types) and 18% talc filled polypropylenes or plastomers. A typical TPO composition is shown in FIG. 4. The plastomer formula designations C2/C4 and C2/C8 refer to carbon blends, where C2 represents ethylene, C4 represents butyl, and C8 represents octyl components supplied by Basell North America Inc., Wilmington, Del.

TABLE 1
TPOs Composition and Physical Properties

| | | | Density | Crystallinity | Melt Flow | Flex Modulus |
|---|---|---|---|---|---|---|
| Sample ID | Polymer Category | Formula Type | (g/cm³) | (%) | (g/10 min) | (MPa) |
| #1-1 | Isotactic PP | Homo | 0.91 | ~55-60 | 5 | 2,140 |
| #1-2 | Isotactic PP | Homo | 0.9 | ~50 | 3.5 | 1,450 |
| #2-1 | Plastomer | C2/C4 | 0.862 | 12 | 1.2 | 4.0 |
| #-2-2 | Plastomer | C2/C4 | 0.901 | 29 | 0.3 | 75.3 |
| #2-3 | Plastomer | C2/C4 | 0.865 | 13 | 5 | 7.6 |
| #-2-4 | Plastomer | C2/C8 | 0.870 | 18 | 1 | 13.1 |
| #2-5 | Plastomer | C2/C8 | 0.870 | 19 | 5 | 10.8 |
| #-2-6 | Plastomer | C2/C8 | 0.868 | 16 | 0.5 | 14.4 |
| #3-1 | #2-1 + 18% talc | N/A | N/A | N/A | N/A | N/A |
| #3-2 | #2-6 + 18% talc | N/A | N/A | N/A | N/A | N/A |
| #3-3 | #1-2 + 18% talc | N/A | N/A | N/A | N/A | N/A |

Each TPO panel (4×6 inches) was half-sanded with sand paper (Gator Grit 100 from ALI Industries, Inc., Fairborn, Ohio), washed to remove any dust, and left to dry overnight. After that, the CPO adhesion promoter coating (20% Superchlon® (chlorinated polyolefins) in xylene from Nippon Paper Chemicals Co. Ltd., Tokyo, Japan) was sprayed on each TPO panel and air dried for 10 minutes. Thereafter, the topcoat (BASF topcoat 1K flexible topcoat for plastics; BASF Corporation, New Jersey) was spayed on each panel and all was baked in a gas oven at 82° C. for 30 minutes. After baking, the panels were allowed to cool to room temperature. The same procedures were repeated and panels were baked at 93° C. and 104° C.

Panels that were baked at 82° C. were completely immersed into a gasoline mixture (45 wt % isooctane, 45 wt % toluene, and 10 wt % ethanol) for 30 minutes, 60 minutes, and 90 minutes. Observations were recorded and the panels that completely failed the adhesion test were removed at each time interval. The same procedures were repeated for panels that were baked at 93° C. and 104° C. A fresh gasoline solution was used for each temperature set.

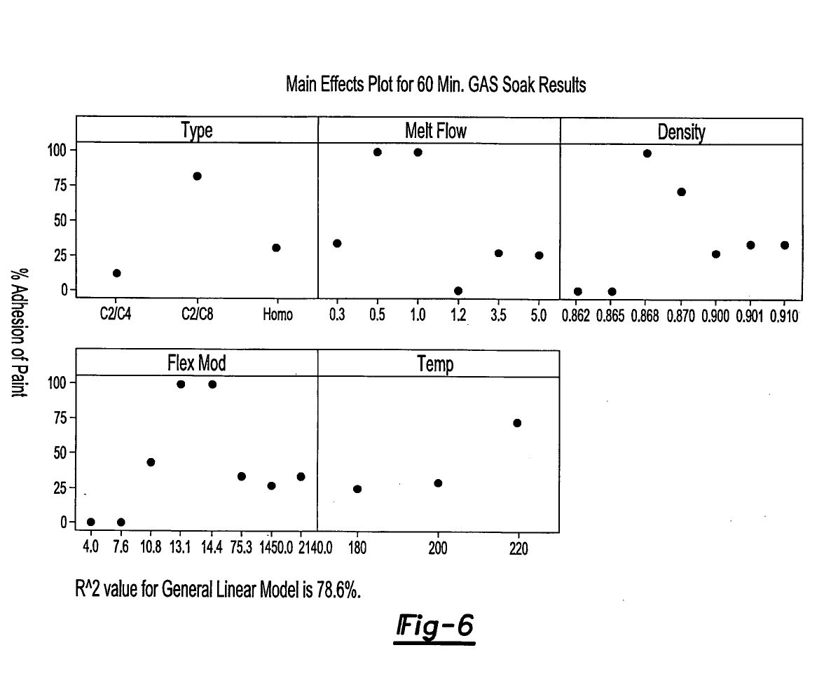

Plots of the effects of TPO type, melt flow, density (top left to right), flex modulus, and temperature (bottom left to right) versus adhesion percentage in gas soak test (vertical axes), are shown in FIGS. 6, 7, and 8. For the y-axes, 100% means complete adhesion of the system and 0% means complete loss of adhesion.

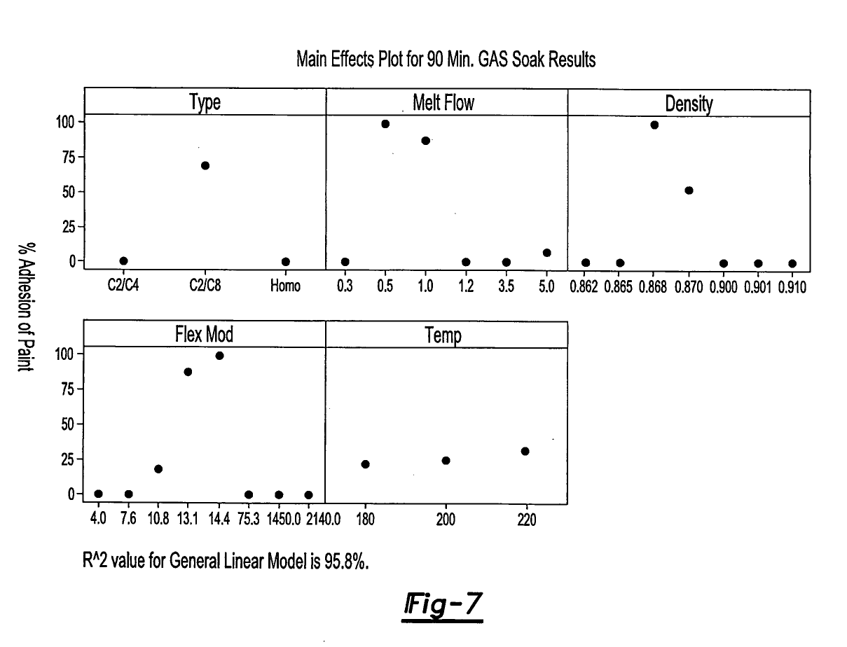

FIG. 6 shows that C2/C8 type of TPO composition had the strongest gasoline resistance among the TPOs in this experiment. It also shows that the gasoline resistance increased as the bake temperature increased. However, as the time of immersion in gasoline mixture increased, increased temperature became less effective, as shown in FIGS. 7 and 8. In general, the adhesion of all TPOs decreased as the test became more severe by longer immersion time. The homo-formulation type had the weakest gasoline resistance because of its single component composition (isotactic polypropylene). Without co-monomer, its high density, high flex modulus, and inert surface did not enhance adhesion.

Both C2/C4 and C2/C8 types had better gasoline resistance than the homo-formula type because of the addition of co-monomer. Addition of C8 produced higher gasoline resistance than that of C4; this may be due to the fact that C4-containing TPO has a higher solvent absorption rate, which in turn reduces adhesion of the system. Also, addition of C8 to the TPO may increase non-polar interactions at CPO-TPO interface, resulting in better adhesion for the overall system. The observed effects are in agreement the chemical mechanisms disclosed herein. A simultaneous decrease in polarity of CPO (forming of unsaturated carbon-carbon bonds, e.g. alkenes) and an increase of polarity of TPO (addition of co-monomer) or non-polar interactions lead to better adhesion. For the TPOs that contain 18% talc, the same trend was observed.

The type of co-monomer in the TPO and the base used in the topcoat can significantly increase gasoline resistance. Simultaneous decrease in the polarity of the CPO and increase in the polarity or non-polar interaction of TPO improves adhesion of the adhesion promoter layer to the TPO substrate. These chemical effects can be accomplished by altering the composition of the TPO by addition of co-monomer to the TPO and addition of a base to the topcoat or second coating layer. Increasing pi bonding (π-π) interactions via base catalysis and dehydrohalogenation, as described, may also increase adhesion with other TPO types or other materials having unsaturated carbon-carbon bonds.

Compositions and methods of the present invention can be used in different ways to increase coating adhesion. For example, a method of coating includes the step of overcoating at least a portion of an adhesion promoter coating with a topcoat, where the adhesion promoter coating includes a compound having a saturated carbon-carbon bond (e.g., the compound may have at least one ethane-1,2-diyl group or substituted ethane-1,2-diyl group) and the topcoat includes a base. The method includes the step of dehydrogenating the saturated carbon-carbon bond of the compound in the adhesion promoter coating catalyzed by the base to form an unsaturated carbon-carbon bond.

The compound having a saturated carbon-carbon bond in the adhesion promoter coating may include a halogen bonded to one carbon of the saturated carbon-carbon bond. For example, the compound in the adhesion promoter coating may be a chlorinated polyolefin. In this case, the dehydrogenating step includes dehydrohalogenation to form the unsaturated carbon bond using the base. The adhesion promoter coating may be applied to at least a portion of a polymeric substrate. The polymeric substrate may be a thermoplastic polyolefin substrate.

The base in the topcoat may be an amine compound, such as a secondary and/or tertiary amine. Suitable amine compounds include 2-amino-2-methylpropanol, trimethylamine, dimethylethanolamine, diethylethanolamine, triethylamine, triethanolamine, diisopropanolamine, triisopropylamine, tributylamine, and combinations thereof. The base may be included in an amount from about 0.01% to about 1.0% by weight of the topcoat.

The present coating methods may include additional steps to cure or dry applied coating layers. For example, an adhesion promoter coating layer may be applied to a substrate followed by a second coating layer in a wet-on-wet process. Or, the adhesion promoter coating layer may be partially cured or dried prior to application of the second coating layer. These methods can further comprise heating the adhesion promoter coating and/or second coating layer (e.g., a topcoat). For example, the method may include an overcoating step that is followed by a heating step. The heating step may improve migration of the base into the adhesion promoter coating from the topcoat or second coating layer. Heating may also improve catalysis by the base to dehydrogenate the saturated carbon-carbon bond of the compound in the adhesion promoter coating to thereby form the unsaturated carbon-carbon bond. Heating may also be used to activate the base. For example, where the base is a blocked amine compound, the heating may unblock the amine to catalyze the dehydrogenation reaction. Heating can include temperatures and bake times typically used in the art for adhesion promoter coatings including CPO that are applied to TPO substrates and then overcoated with a second coating layer. For example, heating may include temperatures from about 80° C. to about 121° C. (i.e., about 180° F. to about 250° F.).

The second coating layer may further include a compound having a hydroxyl group, and the compound having a saturated carbon-carbon bond in the adhesion promoter coating may further include an anhydride group. An example of such a case is illustrated in FIG. 1. Heat may facilitate reaction of the compound having a hydroxyl group in second coating layer with the compound having the anhydride group in the adhesion promoter coating. Reaction of the hydroxyl group and the anhydride can form an ester bond between the hydroxyl group of the compound in the topcoat or second coating layer and the anhydride group of the compound in the adhesion promoter, as illustrated in FIG. 2.

The second coating composition according to the present disclosure, which may be used as a topcoat in some embodiments, may include an organic solvent, a film-forming resin, and a base such as a tertiary amine. The second coating composition may be substantially free of water. The solvent may include one or more organic solvents that are substantially free of water. Substantially free of water indicates that no water, or only trace amounts or residual water, exists in the topcoat composition, and that no water is deliberately added to the topcoat composition. For example, substantially free of water accounts for trace amounts of water typically found in industrial grade solvents and the other components present in the second coating composition. In some embodiments, the topcoat may contain less than 5% water, less than 2% water, or less than 1% water. Suitable second coating compositions and topcoats can be based on the coating compositions described in U.S. Pat. Nos. 6,841,619 and 6,300,414 both to McGee et al.

An adhesion promoter coating composition according to the present disclosure may include an organic solvent; a chlorinated polyolefin; and a blocked amine. The adhesion promoter coating may be substantially free of water. Suitable adhesion promoter coating compositions can be based on those described in U.S. Pat. Nos. 6,841,619 and 6,300,414 both to McGee et al.

The topcoat and/or the adhesion promoter compositions may include a base that requires activation. For example, such a base may be a blocked amine compound where the amine must be unblocked in order to act as a catalyst. Unblocking may occur by heating and may be coupled with a heating step when employing the present compositions and methods. In some cases, the base can be an aldimine, a ketimine, or an oxazolidine. Aldimines are produced by the condensation of aldehydes with primary diamines, followed by removal of the water by-product. Ketimines are produced in a similar fashion, with ketones being utilized in place of the aldehydes. Oxazolidines are produced by condensing either ketones or aldehydes with alkanolamines, with the water by-product again being removed. Examples of forming ketimines from ketones and amines are described in U.S. Pat. No. 4,391,958 to Minato, et al. and U.S. Pat. No. 6,207,733 to Feola et al.

Further examples of bases include triethylamine and dimethylethanolamine. Amount of the base in the coating composition may be about 0.1% to about 1%. Flow additives, rheology agents, and other additives typical to coating compositions may be included.

Compositions and methods of the present disclosure may also increase adhesion by forming covalent bonds between the adhesion promoter coating layer and the substrate. In some embodiments, a free radical initiator may be included in the adhesion promoter coating composition. The free radical initiator forms direct chemical interactions, such as covalent bonds, between the substrate (e.g., TPO) and a component of the adhesion promoter coating layer (e.g., CPO). The free radical initiator may form covalent bonds between the substrate and coating via reaction of alkene, chlorine, alkane, or other groups capable of reacting through a free radical mechanism. The covalent bonds may improve the cohesive bond between the adhesion promoter and the substrate, and can consequently improve the overall adhesion of the topcoat to the substrate.

A method of coating a polymeric substrate includes the step of coating at least a portion of a polymeric substrate with a layer of the adhesion promoter coating including the free radical initiator. This step is followed by the step of initiating the formation of a covalent bond between the adhesion promoter coating and the polymeric substrate using a free radical generated from the free radical initiator. The initiating step may include irradiating and/or heating the coated substrate. Irradiating the adhesion promoter coating may be accomplished using ultraviolet light or an electron beam. Heating the polymeric substrate and layer of adhesion promoter coating may precede, occur concurrently with, or occur subsequent to other steps in the coating process. For example, the polymeric substrate coated with the adhesion promoter may be further coated with a topcoat and then heated to initiate formation of the covalent bond using generated free radicals. Heating may include baking the coated substrate at temperatures from about 80° C. to about 121° C. (about 180° F. to about 250° F.).

In some cases, the free radical initiator may be a photoinitiator. A photoinitiator is a compound especially added to convert absorbed light energy, such as UV or visible light, into chemical energy in the form of initiating species, viz, free radicals or cations. Photoinitiators are generally divided into two classes—Types I and II—based on the mechanism by which initiating radicals are formed. Type I photoinitiators undergo a unimolecular bond cleavage upon irradiation to yield free radicals. Type II photoinitiators undergo a biomolecular reaction where the excited state of the photoinitiator interacts with a second molecule, a free radical coinitiator, to generate free radicals. UV photointiators of both Type I and Type II are known. However, visible light photoinitiators belong almost exclusively to the Type II class of photoinitiators.

The choice of free radical initiator can depend on two factors: a) its solubility and b) its decomposition temperature. The initiator should be compatible with and soluble in the solvent employed and the decomposition temperature of the initiator should be at or below the boiling point of the solvent. Various free radical initiators may be used. Suitable free radical initiators include azo compounds, organic peroxides, dialkyl peroxides, peroxyesters, peroxydicarbonates, diacyl peroxides, hydroperoxides, peroxyketals, and combinations thereof. Additional free radical initiators include 2,2′azobis(2-methylbutanenitrile), 1,1′-azobis(cyclohexanecarbonitrile)di-t-butyl peroxide, t-butyl peroctoate, t-butyl peracetate, t-butyl hydroperoxide, and combinations thereof. Still more free radical initiators include benzoin ethers, benzil ketals, α-dialkoxy-aceto-phenones, α-hydroxy-alkyl-phenones, α-amino-alkyl-phenones, acyl-phosphine oxides, benzo-phenones/amines, thio-xanthones/amines, titanocenes, and combinations thereof. When the free radical initiator is present in the adhesion promoter coating, the free radical initiator may be from about 0.01% to about 5.0% by weight of the adhesion promoter coating.

The present methods of coating a polymeric substrate may include steps employing a topcoat or second coating layer. The invention further provides a method of coating a polymeric substrate including the steps of: coating at least a portion of a polymeric substrate with a layer of an adhesion promoter coating that includes a free radical initiator; initiating the formation of a covalent bond between the adhesion promoter coating and the polymeric substrate using a free radical generated from the free radical initiator; and overcoating at least a portion of the adhesion promoter coating layer with a topcoat or second coating layer. In addition, the polymeric substrate may be heated after the overcoating step and the topcoat may further include a base, such as an amine compound.

Compositions and methods including an adhesion promoter coating having a free radical initiator improve the interaction and adhesion with a substrate. The gasoline soak test is one way to measure adhesion. For example, as shown in Table 2, an adhesion promoter coating including the free radical initiator azobis(cyclohexanecarbonitrile) was much more resistant to gasoline compared to an adhesion promoter without the free radical initiator. Scoring in Table 2 is based on fraction of coating that remained after the gasoline soak; i.e., 3/10=30% of coating remained on the substrate, indicating 70% of coating failed; whereas, 7/10=70% of coating remained, where 30% of coating failed.

TABLE 2
Gasoline Soak Test of Adhesion Promoter Coated Substrate

| | Free Radical | Trail #1, 30 min. | Trial #2, 30 min. |
|---|---|---|---|
| Sample | Initiator (wt %) | Gas Test | Gas Test |
| control | 0.0% | 3/10 | 2/10 |
| test sample | 0.5% | 7/10 | 6/10 |

Compositions and methods of the present disclosure may increase adhesion between both the substrate and adhesion promoter coating and between the adhesion promoter coating layer and the second coating layer. These compositions and methods use an adhesion promoter coating composition having a free radical initiator and a second coating composition having a base. As a result, the free radical initiator may increase adhesion between the adhesion promoter coating layer and the substrate while the base may increase adhesion between the second coating layer and the adhesion promoter coating layer. The combined effects can produce coated substrates having better performance compared to methods employing an adhesion promoter having a free radical initiator with a second coating layer not having a base, or better than methods employing an adhesion promoter layer not having a free radical initiator and a second coating layer having a base. Coated polymeric substrates may be prepared using these topcoats and adhesion promoter coatings.

The present invention also provides methods of coating a polymeric substrate that include applying an adhesion promoter coating to a least a portion of a polymeric substrate, wherein the adhesion promoter coating includes a free radical initiator. The applying is followed by overcoating at least a portion of the adhesion promoter coating with a second coating. The adhesion promoter coating may include a coinitiator and the adhesion promoter coating may include a halogenated polyolefin, such as chlorinated polyolefin (CPO). The polymeric substrate may be a thermoplastic polyolefin substrate.

In some embodiments, the method of coating a polymeric substrate further comprises irradiating the adhesion promoter coating with at least one of ultraviolet light and visible light. The irradiating step can initiate free radical formation, where the free radicals generate covalent bonds between the adhesion promoter coating and the polymeric substrate. In addition to or alternatively, heating of the polymeric substrate after the overcoating step may be used to initiate the free radical formation. The adhesion promoter coating may also include a compound having an anhydride group and the second coating may include a compound having a hydroxyl group.

The present invention also provides methods of coating a polymeric substrate. An adhesion promoter coating is applied to a least a portion of a polymeric substrate, where the adhesion promoter coating includes a compound having a saturated carbon-carbon bond. At least a portion of the adhesion promoter coating is then overcoated with a second coating layer, where the second coating includes a base. In some cases, the polymeric substrate may be heated after it is overcoated with the second coating. The adhesion promoter coating may also include a free radical initiator and may further include a free radical coinitiator.

The present compositions and methods can also be used to produce coated polymeric substrates. Such coated polymeric substrates can have improved adhesion between the topcoat-adhesion promoter interface and between the adhesion promoter-substrate interface. For example, the overall coating system including the TPO substrate, CPO-based adhesion promoter coating, and the second coating layer exhibits better adhesion in tests, such as the gasoline soak test, and results in a more durable coated polymeric substrate.

All literature and similar materials cited in this disclosure, including but not limited to, patents, patent applications, articles, books, treatises, and internet web pages, regardless of the format of such literature and similar materials, are expressly incorporated by reference in their entirety for any purpose. In the event that one or more of the incorporated literature and similar materials differs from or contradicts this disclosure, including but not limited to defined terms, term usage, described techniques, or the like, this disclosure controls.

The description of the technology is merely exemplary in nature and, thus, variations that do not depart from the gist of the present invention are intended to be within the scope of the invention. Such variations are not to be regarded as a departure from the spirit and scope of the invention.

What is claimed is:

1. A method of coating a polymeric substrate comprising:
coating at least a portion of a polymeric substrate with a layer of an adhesion promoter coating, the adhesion promoter coating comprising a free radical initiator; and
forming a covalent bond between the adhesion promoter coating and the polymeric substrate using a free radical generated from the free radical initiator.

2. The method of coating a polymeric substrate according to claim 1, wherein the free radical is generated by at least one of:
irradiating the adhesion promoter coating with ultraviolet light or an electron beam; and
heating the polymeric substrate and layer of adhesion promoter coating.

3. The method of coating a polymeric substrate according to claim 1, wherein the adhesion promoter coating further comprises a chlorinated polyolefin.

4. The method of coating a polymeric substrate according to claim 1, wherein the polymeric substrate is a thermoplastic polyolefin substrate.

5. The method of coating a polymeric substrate according to claim 1, wherein the free radical initiator is selected from the group consisting of azo compounds, organic peroxides, dialkyl peroxides, peroxyesters, peroxydicarbonates, diacyl peroxides, hydroperoxides, peroxyketals, and combinations thereof.

6. The method of coating a polymeric substrate according to claim 1, wherein the free radical initiator is selected from the group consisting of 2,2′azobis(2-methylbutanenitrile), 1,1′-azobis(cyclohexanecarbonitrile)di-t-butyl peroxide, t-butyl peroctoate, t-butyl peracetate, t-butyl hydroperoxide, and combinations thereof.

7. The method of coating a polymeric substrate according to claim 1, wherein the adhesion promoter coating comprises from about 0.01% to about 5.0% by weight of the free radical initiator.

8. The method of coating a polymeric substrate according to claim 1, wherein the adhesion promoter coating further comprises a free radical coinitiator.

9. The method of coating a polymeric substrate according to claim 1, further comprising overcoating at least a portion of the adhesion promoter coating layer with a second coating layer.

10. The method of coating a polymeric substrate according to claim 9, further comprising heating the polymeric substrate after the overcoating step.

11. The method of coating a polymeric substrate according to claim 9, wherein the second coating layer further comprises a base.

12. The method of coating a polymeric substrate according to claim 11, wherein the base comprises an amine compound.

13. A method of coating a polymeric substrate comprising:
applying an adhesion promoter coating to a least a portion of a polymeric substrate, wherein the adhesion promoter coating includes a free radical initiator; and
overcoating at least a portion of the adhesion promoter coating with a second coating layer.

14. The method of coating a polymeric substrate according to claim 13, wherein the adhesion promoter coating further comprises a free radical coinitiator.

15. The method of coating a polymeric substrate according to claim 13, further comprising irradiating the adhesion promoter coating with at least one of ultraviolet light and visible light.

16. The method of coating a polymeric substrate according to claim 13, wherein the adhesion promoter coating further comprises a halogenated polyolefin.

17. The method of coating a polymeric substrate according to claim 16, wherein the halogenated polyolefin is chlorinated polyolefin.

18. The method of coating a polymeric substrate according to claim 13, wherein the polymeric substrate is a thermoplastic polyolefin substrate.

19. The method of coating a polymeric substrate according to claim 13, further comprising heating the polymeric substrate after the overcoating step.

20. The method of coating a polymeric substrate according to claim 13, wherein the adhesion promoter coating further comprises a compound having an anhydride group and the second coating layer further comprises a compound having a hydroxyl group.

21. The method of coating a polymeric substrate according to claim 13, wherein the second coating layer further comprises a base.

22. The method of coating a polymeric substrate according to claim 21, wherein the base comprises an amine compound.

23. A coated polymeric substrate prepared according to the method of claim 13.

24. A coated polymeric substrate prepared according to the method of claim 21.
